(19) United States
(12) Patent Application Publication
(10) Pub. No.: US 2022/0024295 A1
(43) Pub. Date: Jan. 27, 2022

(54) Hybrid Transmission for a Motor Vehicle

(71) Applicant: ZF Friedrichshafen AG, Friedrichshafen (DE)

(72) Inventors: Johannes Kaltenbach, Friedrichshafen (DE); Uwe Griesmeier, Markdorf (DE); Stefan Beck, Eriskirch (DE); Matthias Horn, Tettnang (DE); Fabian Kutter, Kressbronn (DE)

(21) Appl. No.: 17/427,385

(22) PCT Filed: Dec. 17, 2019
(86) PCT No.: PCT/EP2019/085554

§ 371 Date: Jul. 30, 2021

(30) Foreign Application Priority Data
Feb. 1, 2019 (DE) 10 2019 201 298.1

(51) Int. Cl. B60K 6/547; B60K 6/48; B60K 6/365

(52) U.S. Cl. CPC B60K 6/547; B60K 6/48; B60K 2006/4825; B60K 2006/4816; B60K 6/365

(57) ABSTRACT

A hybrid transmission (10) for a motor vehicle with an internal combustion engine (VM) and an electric prime mover (EM1) is provided. The hybrid transmission (10) includes a first transmission input shaft (14) for a first sub-transmission, a second transmission input shaft (16) for a second sub-transmission, at least one countershaft (18), multiple gear change devices (A-F) for engaging gear steps (E1, E2, 1, 2, 3, 4), and idler gears and fixed gears arranged in multiple gear set planes for forming the gear steps. A portion of the gear steps are engageable for the internal combustion engine, and a portion of the gear steps are engageable for the electric prime mover. At least one of the gear steps is engageable for the internal combustion engine and for the electric prime mover regardless of the gear step engaged for the particular other machine.

### CROSS-REFERENCE TO RELATED APPLICATIONS

The present application is related and has right of priority to German Patent Application No. 102019201298.1 filed in the German Patent Office on Feb. 1, 2019 and is a nationalization of PCT/EP2019/085554 filed in the European Patent Office on Dec. 17, 2019, both of which are incorporated by reference in their entirety for all purposes.

### FIELD OF THE INVENTION

The present invention relates generally to a hybrid transmission for a motor vehicle and a drive train for a motor vehicle with a hybrid transmission of this type and to a motor vehicle with a drive train of this type.

### BACKGROUND

Vehicles are increasingly equipped with hybrid drives, i.e., with at least two different drive sources. Hybrid drives can contribute to the reduction of fuel consumption and pollutant emissions. Drive trains having an internal combustion engine and one or multiple electric motors have largely prevailed as a parallel hybrid or as a mixed hybrid. These types of hybrid drives have an essentially parallel arrangement of the internal combustion engine and of the electric drive in the power flow. Here, a superposition of the drive torques and an actuation with a purely internal combustion engine-generated drive or a purely electric motor-generated drive is made possible. Since the drive torques of the electric drive and of the internal combustion engine can add up, depending on the actuation, a comparatively smaller configuration of the internal combustion engine and/or intermittent shut-down of the internal combustion engine are/is possible, as the result of which a significant reduction of the carbon dioxide (CO₂) emissions can be achieved without significant losses of power and/or comfort. The possibilities and advantages of an electric drive can thereby be combined with the range, power, and cost advantages of internal combustion engines.

One disadvantage of the aforementioned hybrid drives is a comparatively high weight, since at least two drive sources and energy accumulators must also be transported. In addition, there is an increased probability of failure of at least one drive source due to the higher number of drive sources. Hybrid transmissions generally have a more complex configuration, since both drive sources transmit input power to a drive shaft preferably with only one transmission. A reduction of the complexity of the configuration of a hybrid transmission is usually associated with a loss of variability.

Publication DE 10 2010 030 573 A1 describes a hybrid drive with an automated manual transmission, for example, for a motor vehicle. The manual transmission includes an internal combustion engine, which is drivingly connected to at least one first transmission input shaft, and an electric drive, which has at least one electric machine, which is drivingly connected to a second transmission input shaft. In order to allow for a high variability with regard to a gear set concept as well as the distribution and the number of electric and internal-combustion-engine gears, to keep the design complexity and costs low, and to ensure an efficient and comfortable operation, the two transmission input shafts are arranged coaxially to each other, and a gear change device, in one of the shift positions of the gear change device, drivingly connects the two transmission input shafts to each other and, in another shift position, shifts a gear.

Here, it is disadvantageous that the gear steps associated with the internal combustion engine can be combined with the gear steps associated with the electric machine only to a limited extent. When the electric machine utilizes, for example, the shorter of the two gear steps associated therewith, the internal combustion engine cannot simultaneously utilize the longer of these two gear steps.

### SUMMARY OF THE INVENTION

Example aspects of the present invention provide a hybrid transmission and a drive train having a better combinability of the internal-combustion-engine and electric-motor gear steps. In particular, a hybrid transmission and a drive train are provided, which, due to their properties with regard to small installation space and high variability, are suitable for a serial production in the automotive industry. Preferably, all gear steps are to be usable with an internal combustion engine when a low gear step is engaged for the electric machine.

The invention relates, in a first example aspect, to a hybrid transmission for a motor vehicle having an internal combustion engine and an electric prime mover, with:
a first transmission input shaft for a first sub-transmission;
a second transmission input shaft for a second sub-transmission;
at least one countershaft;
multiple gear change devices for engaging gear steps; and
idler gears and fixed gears arranged in multiple gear set planes for forming the gear steps, wherein
a portion of the gear steps is engageable for the internal combustion engine and a portion of the gear steps is engageable for the electric prime mover; and
at least one of the gear steps is engageable for the internal combustion engine and for the electric prime mover and, in fact, regardless of the gear step engaged for the particular other machine.

In a further example aspect, the invention relates to a drive train with:
an internal combustion engine for providing input power;
an electric prime mover for providing input power; and
the above-described hybrid transmission.

In addition, example aspects of the invention relate to a motor vehicle with:
an energy accumulator for storing energy for supplying electric prime movers and vehicle electronics;
a main power circuit for transmitting energy from the energy accumulator and/or from an electric prime mover operated as a charging generator; and
the above-described drive train.

Due to the fact that at least one of the gear steps is engageable for the internal combustion engine and for the electric prime mover and, in fact, regardless of the gear step engaged for the particular other machine, the hybrid transmission can be designed to be compact and, thereby, variable. Since at least one gear step can be utilized independently of the internal combustion engine and the electric prime mover, the hybrid transmission can have one fewer pair of spur gears given the same number of gear steps. The hybrid transmission can be designed to be compact, without having to accept losses in the number of gear steps. Moreover, due to the elimination of one pair of spur gears, the weight of the hybrid transmission can be reduced and the hybrid transmission can have a high efficiency. In addition, the assembly is simplified, in particular, since fewer parts for the transmission need to be produced and kept in stock.

In one preferred example embodiment, the hybrid transmission has four gear steps, wherein the first two gear steps are engageable for the electric prime mover. The second gear step is engageable for the internal combustion engine and for the electric prime mover. The gear steps one through four are engageable for the internal combustion engine when the first gear step is engaged for the electric prime mover. In addition, the gear steps two through four are engageable for the internal combustion engine when the second gear step is engaged for the electric prime mover. Due to the provision of four gear steps, the hybrid transmission can be designed to be weight- and cost-efficient. The hybrid transmission has a low installation space requirement, and so an application for small vehicles is also possible. Due to the combinability of the gear steps, a high variability and efficiency of the hybrid transmission can be achieved.

In one preferred example embodiment, the first transmission input shaft and the second transmission input shaft are arranged coaxially to each other. In addition, a gear change device, in one shift position, drivingly connects the two transmission input shafts to each other. As a result, the hybrid transmission has a compact design. Moreover, due to the advantageous arrangement of the transmission input shafts, a shared countershaft can be utilized, which simplifies the assembly of the hybrid transmission. Due to a connection of the two transmission input shafts, the variability can be further increased.

In one preferred example embodiment, the gear change devices are designed as double shift elements, which are actuatable by a double-acting actuator. In addition, the two gear steps engageable for the electric prime mover are engageable by a double shift element. Due to the provision of double shift elements, the actuation during gear changes can be simplified. In addition, the number of actuators needed for the open-loop control of the hybrid transmission can be kept low. The hybrid transmission can be designed to be cost-efficient and less susceptible to error. Due to the provision of a double shift element for the two gear steps engageable for the electric prime mover, the open-loop control of the hybrid transmission in a purely electric operation is simplified.

In one preferred example embodiment, an idler gear of the gear set that forms the second gear step is arranged at a hollow shaft. As a result, it can be ensured in a technically simple way that the second gear step is engageable for the internal combustion engine and for the electric prime mover and, in fact, regardless of the gear step engaged for the particular other machine.

In one preferred example embodiment, the electric prime mover is actuatable as an integrated starter generator for starting the internal combustion engine and/or as a charging generator for charging an energy accumulator or for supplying a main power circuit. In this way, the hybrid transmission can be efficiently operated. For example, a stationary charging is possible. The fuel consumption can be reduced. Moreover, an additional starter for the internal combustion engine can be omitted.

In one preferred example embodiment, the internal combustion engine is directly operatively connected to the first transmission input shaft. The electric prime mover is actuatable as a starting component for starting the motor vehicle. As a result, a launch clutch, which is expensive and complex in terms of open-loop control, in particular in the form of a friction clutch, can be omitted. The hybrid transmission can be relatively compact, simple, and cost-efficient in production.

In one preferred example embodiment, the second transmission input shaft is designed as a hollow shaft and encompasses, at least partially or in sections, the first transmission input shaft. As a result, the transmission can be designed to be compact.

In one preferred example embodiment of the drive train, the electric prime mover is at least partially actuatable as a supporting force during gear changes of the internal combustion engine. As a complement or a supplement, the internal combustion engine is at least partially actuatable as a supporting force during gear changes of the electric prime mover. As a result, a comfortable changeover of the gear stages is made possible. Moreover, the hybrid transmission has lower wear and a higher stability against failure.

In one preferred example embodiment of the drive train, the drive train has a second electric prime mover, which is connected in series with the internal combustion engine on the first transmission input shaft. As a result, the internal combustion engine can be designed having smaller dimensions, since assistance is possible by the second electric prime mover. A consumption of fossil fuels can be reduced.

A gear step changeover takes place by disengaging one shift element and simultaneously engaging the shift element for the next-higher or next-lower gear step. The second shift element therefore gradually takes on the torque from the first shift element, until, by the end of the gear step changeover, the entire torque has been taken on by the second shift element.

Entraining the internal combustion engine into motion is understood to mean starting the internal combustion engine or setting the internal combustion engine into rotation. The entrainment into motion takes place by at least partially engaging a friction clutch with a gear step engaged and the ignition switched on, wherein the ‘momentum’ of a vehicle in motion, i.e., kinetic energy, is transmitted by the power train to the internal combustion engine.

In the present case, an internal combustion engine can be any machine that can generate a movement and/or a turning motion by burning a fuel, such as gasoline fuel, diesel fuel, kerosene, ethanol, liquefied gas, liquefied petroleum gas, etc. An internal combustion engine can be, for example, a spark-ignition engine, a diesel engine, a Wankel rotary piston engine®, or a two-stroke engine.

An actuator in the present case is a component that converts an electrical signal into a mechanical motion. Preferably, actuators that are utilized with double shift elements carry out movements in two opposite directions, in order to engage one shift element of the double shift element in the first direction and to engage the other shift element in the second direction.

A serial driving operation is understood to be an operating mode, in which the internal combustion engine acts as a drive for an electric prime mover operated as a generator, which supplies a second electric prime mover, and so the internal combustion engine is decoupled from the driving wheels and, preferably, can be operated continuously at a single, low-emission operating point.

Stationary charging is understood to be the operation of the electric prime mover as a generator, preferably while the vehicle is at rest with the internal combustion engine running, in order to charge an energy accumulator and/or to supply onboard electronics.

### BRIEF DESCRIPTION OF THE DRAWINGS

Example aspects of the invention are described and explained in greater detail in the following with reference to a few selected exemplary embodiments in conjunction with the attached drawings, in which:

FIG. 1 shows a schematic of an embodiment of a hybrid transmission according to the invention in a first example variant;

FIG. 2 shows a schematic of a gear shift matrix of the hybrid transmission according to example aspects of the invention;

FIG. 3 shows a schematic of an embodiment of a hybrid transmission according to the invention in a second example variant;

FIG. 4 shows a schematic of an embodiment of a hybrid transmission according to the invention in a third example variant;

FIG. 5 shows a schematic of an embodiment of a hybrid transmission according to the invention in a fourth example variant;

FIG. 6 shows a schematic of an embodiment of a hybrid transmission according to the invention in a fifth example variant;

FIG. 7 shows a schematic of an embodiment of a hybrid transmission according to the invention in a sixth example variant;

FIG. 8 shows a schematic of an embodiment of a hybrid transmission according to the invention in a seventh example variant;

FIG. 9 shows a schematic of an embodiment of a hybrid transmission according to the invention in an eighth example variant;

FIG. 10 shows a schematic of an embodiment of a hybrid transmission according to the invention in a ninth example variant; and

FIG. 11 shows a schematic of an embodiment of a hybrid transmission according to the invention in a tenth example variant.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

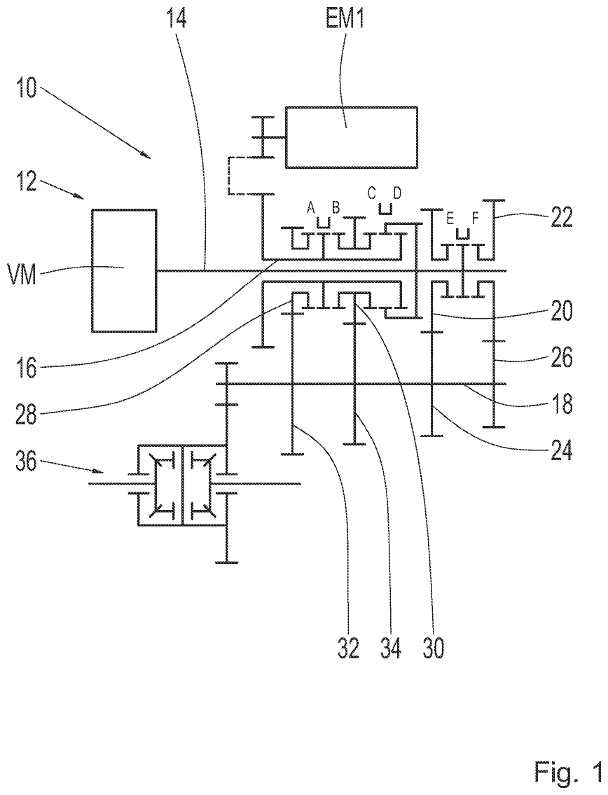

FIG. 1 diagrammatically shows an example embodiment of a hybrid transmission 10 in a drive train 12 with a first transmission input shaft 14, a second transmission input shaft 16, and a countershaft 18. The first transmission input shaft 14 is designed as a solid shaft and is drivingly connected to an internal combustion engine VM. The second transmission input shaft 16 is designed as a hollow shaft and is drivingly connected to an electric prime mover EM1. Arranged at the first transmission input shaft 14 are two idler gears 20, 22 designed as spur gears, which mesh with two fixed gears 24, 26 of the countershaft 18, which are also designed as spur gears, in order to form the spur gear stages i3 and i4. Arranged at the second transmission input shaft 16 are two idler gears 28, 30 designed as spur gears, which mesh with two fixed gears 32, 34 of the countershaft 18, which are also designed as spur gears, in order to form the spur gear stages i1 and i2. The countershaft 18 is drivingly connected, via a gearwheel pair having an output spur gear stage iab, to a differential 36, which directs input power to driving wheels (not shown here).

The first transmission input shaft 14 and the second transmission input shaft 16 are arranged coaxially to each other and parallel to the countershaft 18. The second transmission input shaft 16 encompasses, at least partially or in sections, the first transmission input shaft 14. The idler gears 28, 30 of the second transmission input shaft 16 are rotationally fixable to the second transmission input shaft 16 by the shift elements A, B. The idler gears 20, 22 of the first transmission input shaft 14 are rotationally fixable to the first transmission input shaft 14 by the shift elements E, F. The first transmission input shaft 14 is drivingly connectable to the second transmission input shaft 16 by a shift element D. The idler gear 30 forming, with the fixed gear 34, the spur gear stage i2, is drivingly connectable to the first transmission input shaft 14 by a shift element C. The shift elements A, B, C, D, E, F are designed as double shift elements AB, CD, EF, which are arranged at the two transmission input shafts 14, 16. The first transmission input shaft 14 and the second transmission input shaft 16 form, with the countershaft 18, a sub-transmission in each case.

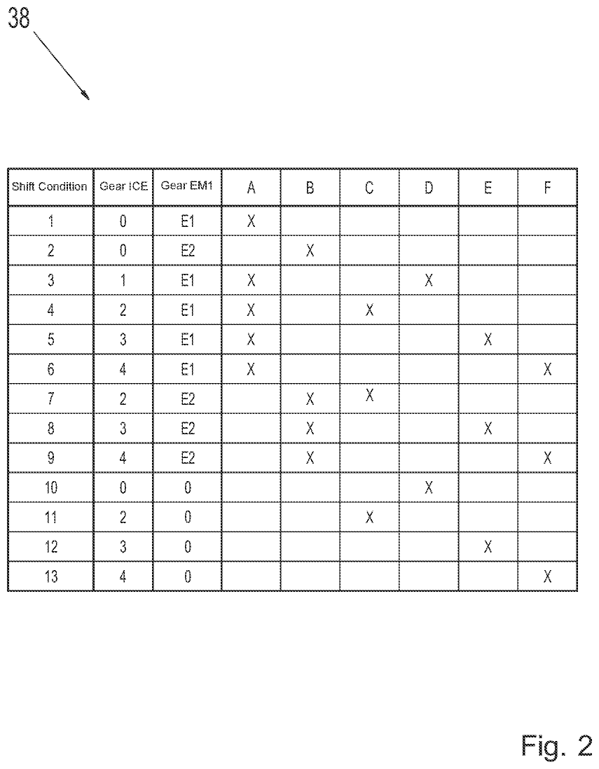

FIG. 2 shows a gear shift matrix 38 of the hybrid transmission from FIG. 1 and of the following example embodiments of hybrid transmissions. Thirteen shift conditions, overall, are represented in the first column. In the second column, the gear steps of the internal combustion engine VM designated as internal-combustion-engine gear steps are represented, wherein “0” means that no input power from the internal combustion engine VM is transmitted to the countershaft 18. In the third column, the gear steps of the electric prime mover EM1 designated as electric-machine gear steps are represented, wherein “0” means that no input power from the electric prime mover EM1 is transmitted to the countershaft 18. In the fourth to ninth columns, the shift conditions of the shift elements A, B, C, D, E, F are shown, wherein “X” means that the shift element is engaged, i.e., the idler gear associated therewith is rotationally fixed to the shaft associated therewith. The shift element A is associated with the idler gear 28, which, with a fixed gear 32, forms the first spur gear stage i1. The shift element B is associated with the idler gear 30, which, with a fixed gear 34, forms the second spur gear stage i2. The shift element C is also associated with the idler gear 30, which, with a fixed gear 34, forms the second spur gear stage i2. The shift element D drivingly connects the first transmission input shaft 14 and the second transmission input shaft 16. The shift element E is associated with the idler gear 20, which, with a fixed gear 24, forms the third spur gear stage i3. The shift element F is associated with the idler gear 22, which, with a fixed gear 26, forms the fourth spur gear stage i4.

In a purely electric operation, the electric prime mover can transmit input power by the electric-machine gear steps E1 and E2, i.e., the spur gear stages i1 and i2, for power transmission. These two electric-machine gear steps can be engaged by the double shift element AB. The other shift elements, C, D, E; F, are in a neutral position, i.e., do not connect the idler gear associated therewith to the shaft associated with the shift element.

In a hybrid operation, the electric prime mover EM1 transmits input power by the electric-machine gear steps E1 or E2. Additionally, the internal combustion engine VM transmits input power by the internal-combustion-engine gear steps 1, 2, 3, 4 formed by the spur gear stages i1, i2, i3, i4. The vehicle is in an operating condition, in which input power is provided by the electric prime mover EM1 as well as by the internal combustion engine VM. The internal-combustion-engine gear steps 3 and 4 are engaged by the double shift element EF. The internal-combustion-engine gear steps 1 and 2 are engaged by the double shift element CD. The internal-combustion-engine gear steps 1 and 2 are established by the same gearwheel pairs or spur gear stages i1, i2 as the electric-machine gear steps E1 and E2. In order to engage the first internal-combustion-engine gear step, the two transmission input shafts 14, 16 are drivingly connected to each other by the shift element D, and the shift element A is engaged. In order to engage the second internal-combustion-engine gear step, the shift element C is engaged. During the hybrid operation, all internal-combustion-engine gear steps 1, 2, 3, 4 are engageable when the electric prime mover utilizes the first electric-machine gear step E1. The internal-combustion-engine gear steps 2, 3, 4 are engageable when the electric prime mover utilizes the second electric-machine gear step E2.

In a purely internal combustion engine-driven operation, the internal combustion engine VM can transmit input power by the internal-combustion-engine gear steps 2, 3, 4. The electric prime mover EM1 is not operated in this case. The internal-combustion-engine gear steps 3 and 4 are engaged by the double shift element EF. The internal-combustion-engine gear step 2 is engaged by the shift element C. The shift element D drivingly connects the first transmission input shaft 14 and the second transmission input shaft 16, in order to operate the electric prime mover EM1 as a generator and charge an energy accumulator, for example, while the vehicle is at rest with the internal combustion engine VM running. Moreover, as a result, the electric prime mover EM1 can be utilized as a starter for the internal combustion engine VM.

In the example embodiment shown in FIG. 1, the shift element A rotationally fixes the idler gear 28 to the second transmission input shaft 16. The shift element B rotationally fixes the idler gear 30 to the second transmission input shaft 16. The shift element C rotationally fixes the idler gear 30 to the first transmission input shaft 14. The shift element E connects the idler gear 20 to the first transmission input shaft 14. The shift element F connects the idler gear 22 to the first transmission input shaft 14.

In the following, identical reference characters refer to identical features and are not explained in greater detail. Preferably, only the differences in the example variants of hybrid transmissions are discussed.

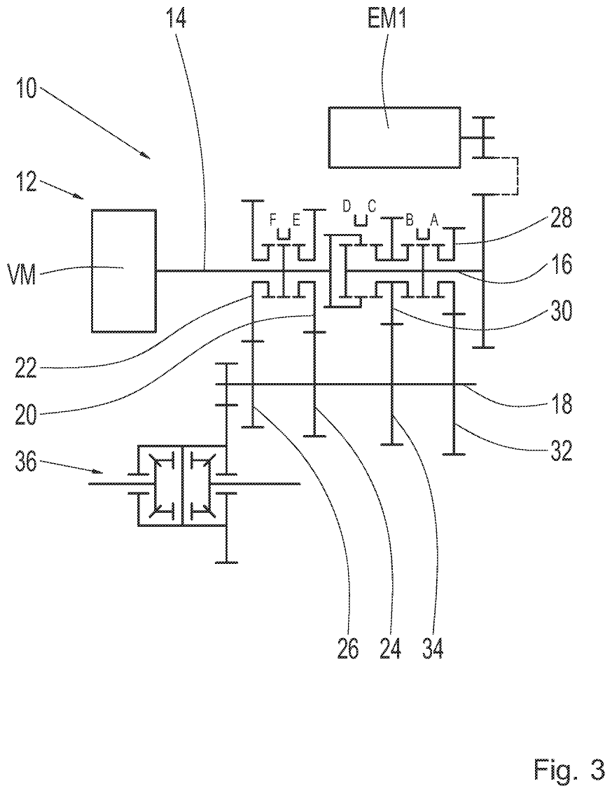

In FIG. 3, a second example variant of a hybrid transmission 10 according to the invention is shown in a drive train 12. In contrast to the hybrid transmission shown in FIG. 1, the second transmission input shaft 16 is also designed as a solid shaft. In addition, the electric prime mover EM1 is arranged at the end of the hybrid transmission 10 opposite the internal combustion engine VM. The gearwheel pairs for forming the internal-combustion-engine gear steps 3, 4 are arranged adjacent to the internal combustion engine VM. The transmission input shafts 14, 16 are mounted one inside the other in a center of the hybrid transmission 10.

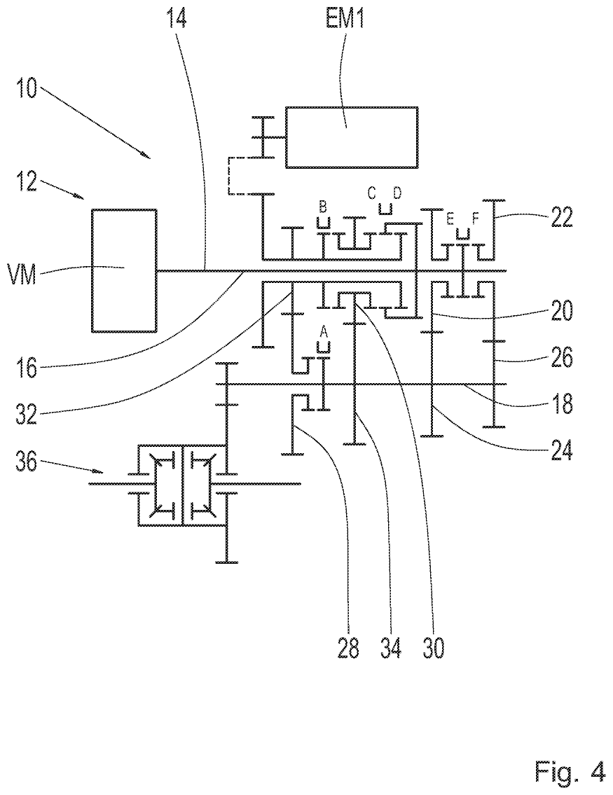

In FIG. 4, a third example variant of a hybrid transmission 10 according to the invention is shown in a drive train 12. In contrast to the hybrid transmission 10 shown in FIG. 1, the shift element A is located at the countershaft 18. As a result, the gearwheel pair 28, 32 forming the first spur gear stage i1 has one fewer hollow shaft. The double shift element AB is less easily representable. For example, a shared shift rail having two separate shift forks can be utilized.

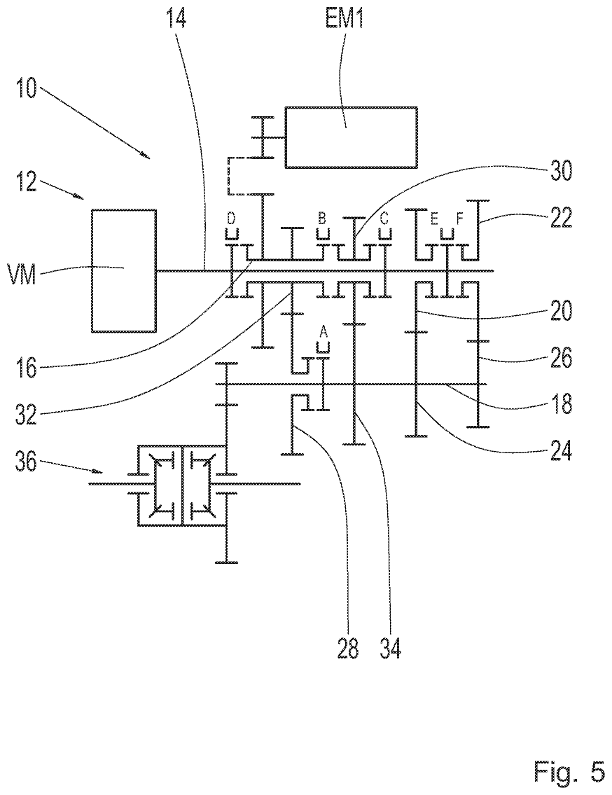

In FIG. 5, a fourth example variant of a hybrid transmission 10 according to the invention is shown in a drive train 12. In contrast to the hybrid transmission 10 shown in FIG. 4, the shift element D is located at a transmission input, i.e., adjacent to the internal combustion engine VM. As a result, the gearwheel pair 30, 34 forming the second spur gear stage i2 has one fewer hollow shaft. The double shift element CD is less easily representable. For example, a shared shift rail having two separate shift forks can be utilized.

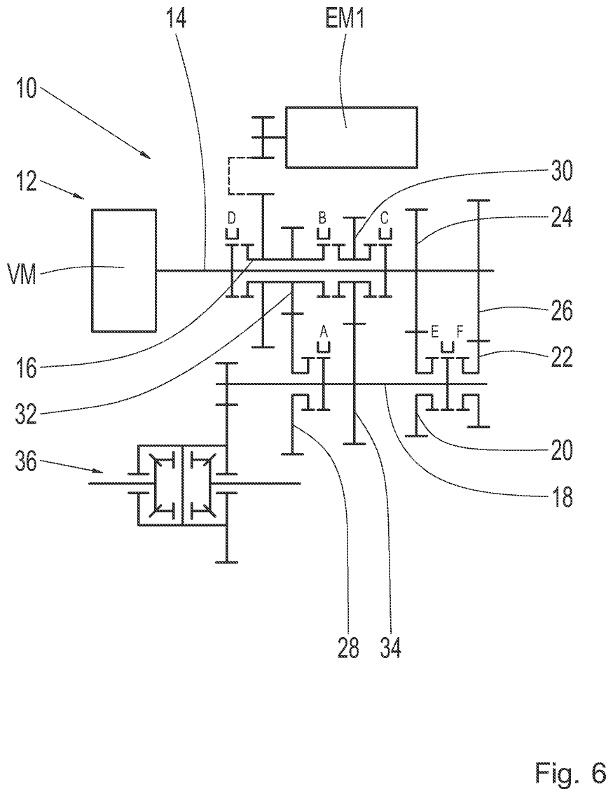

In FIG. 6, a fifth example variant of a hybrid transmission 10 according to the invention is shown in a drive train 12. In contrast to the hybrid transmission 10 shown in FIG. 5, the double shift element EF is arranged on the countershaft 18.

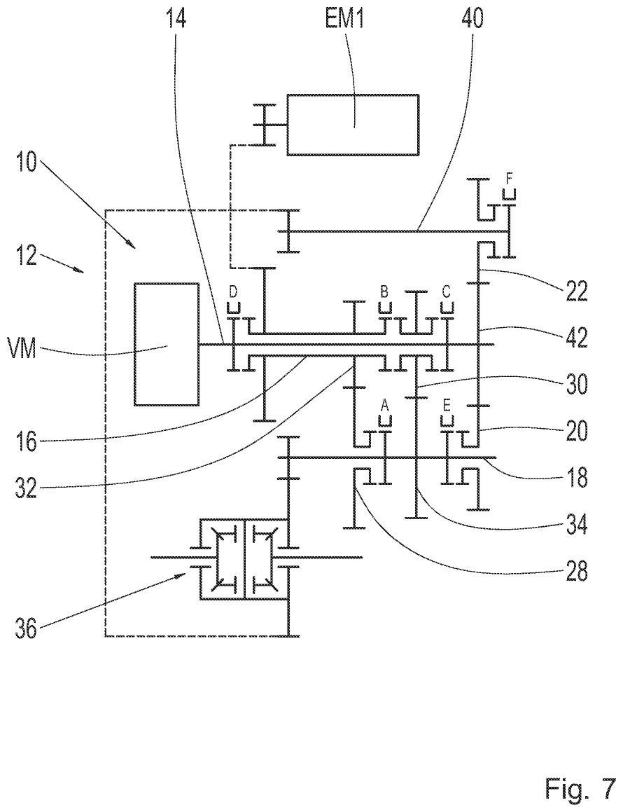

In FIG. 7, a sixth example variant of a hybrid transmission 10 according to the invention is shown in a drive train 12. In contrast to the hybrid transmission 10 shown in FIG. 6, one further countershaft 40 is provided. The further countershaft 40 is drivingly connected to the differential 36 via a gearwheel pair of a further output spur gear stage iab2. The idler gear 22 is arranged on the further countershaft 40, in order to design the hybrid transmission 10 with a shorter axial installation length. The double shift element EF is less easily representable. For example, a shared shift rail having two separate shift forks can be utilized. The spur gear stages i3 and i4 utilize a shared fixed gear 42 on the first transmission input shaft 14. The fact that spur gear stage i4 represents a “longer” (i.e., less small) spur gear stage than spur gear stage i3 can be achieved in that the idler gear 22 of spur gear stage i4 is selected to be smaller than the idler gear 20 of spur gear stage i3. Alternatively or in combination therewith, the further output spur gear stage iab2 can be designed to be “longer” than the output spur gear stage iab. The unoccupied axial installation space on the further countershaft 40 can be utilized, for example, for a parking lock.

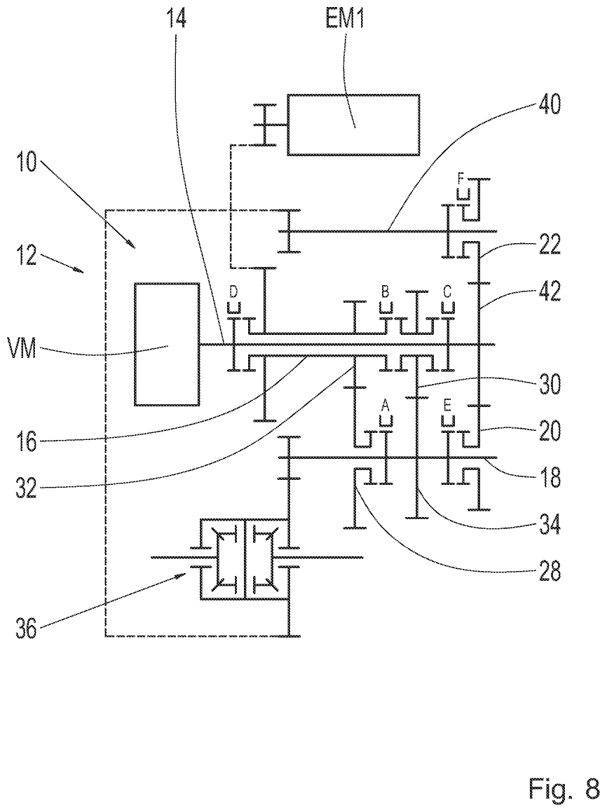

In FIG. 8, a seventh example variant of a hybrid transmission 10 according to the invention is shown in a drive train 12. In contrast to the hybrid transmission 10 shown in FIG. 7, the shift element F is arranged on the side of the idler gear 22 facing the internal combustion engine VM. The hybrid transmission is axially shorter.

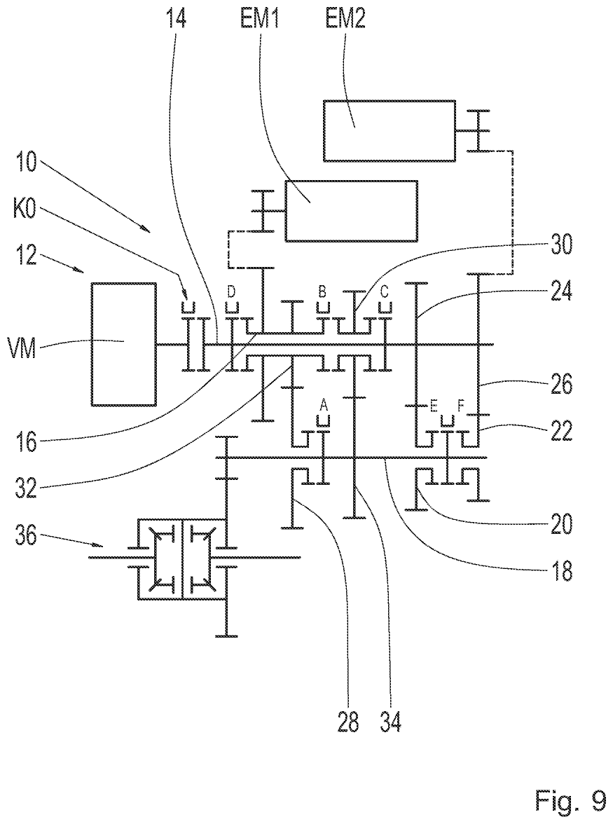

In FIG. 9, an eighth example variant of a hybrid transmission 10 according to the invention is shown in a drive train 12. In contrast to the hybrid transmission 10 shown in FIG. 6, a second electric prime mover EM2 is provided. The second electric prime mover EM2 is connected to the first transmission input shaft 14 by a spur gear stage. It is understood that a connection by a flexible traction drive mechanism can also be provided. In addition, a separating clutch K0 is provided between the first transmission input shaft 14 and the internal combustion engine VM. As a result, the second electric prime mover EM2 can be utilized, instead of the internal combustion engine VM, in a purely electric operation when the internal combustion engine VM is separated from the first transmission input shaft 14. The second electric prime mover EM2 can take over the functions of the internal combustion engine VM, such as, for example, applying supporting force during gear changes of the first electric machine EM1.

The second electric prime mover EM2 can be utilized in a hybrid operation for assisting the internal combustion engine VM. The clutch K0 is designed to be form-locking. It is understood that a friction-locking clutch can also be utilized, in order, for example, to allow for a purely internal combustion engine-driven starting operation. If the clutch K0 is engaged, i.e., the first transmission input shaft 14 is drivingly connected to the internal combustion engine VM, the following functions are possible: a start of the internal combustion engine VM from a purely electric operation; the supply of a main power circuit of a hybrid vehicle by the internal combustion engine VM, which drives the second electric prime mover, which acts as a generator; a serial driving operation forward and also in reverse. Here, the internal combustion engine VM drives the second electric prime mover as a generator. The electrical energy generated by the second electric machine EM2 (generator) is then supplied to the electric prime mover EM1, and so the electric prime mover EM1 can provide input power. The electric prime mover EM1 can be operated in both directions of rotation, in order to allow for forward travel and travel in reverse. It is understood that the clutch K0 can also be omitted, depending on which functions are to be represented with the hybrid transmission 10.

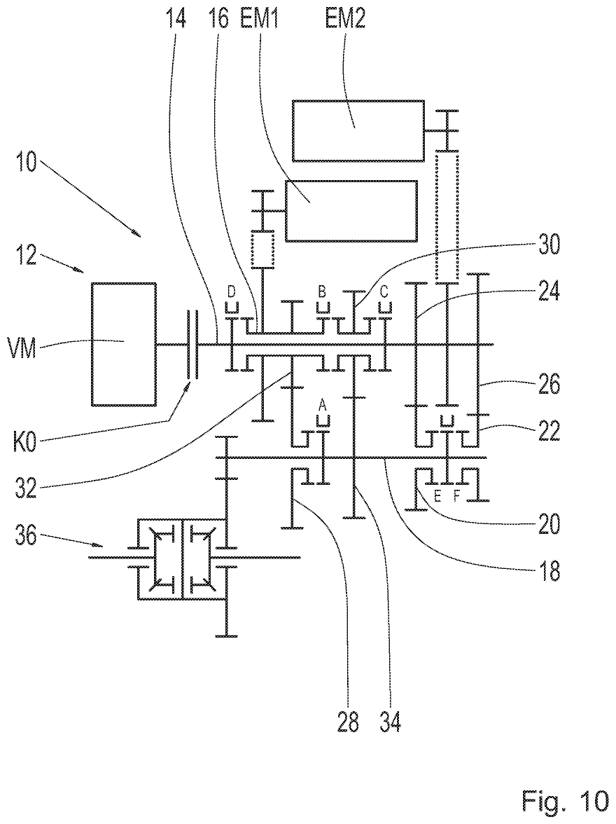

In FIG. 10, a ninth example variant of a hybrid transmission 10 according to the invention is shown in a drive train 12. In contrast to the hybrid transmission 10 shown in FIG. 9, the two electric prime movers EM1, EM2 are each connected to the hybrid transmission 10 by a chain drive. Moreover, the clutch K0 is designed as a friction-locking clutch, in order to allow for the following functions: disengage the clutch K0 under load, such as, for example, during an emergency brake application; a purely internal combustion engine-driven starting operation; entrainment of the internal combustion engine VM into motion during travel, in order to start the internal combustion engine VM; flywheel start of the internal combustion engine VM by the second electric prime mover EM2. Moreover, an engagement of the clutch K0 is simplified, since a synchronization can be omitted or, preferably, only a small synchronization is necessary. It is understood that, in this example embodiment, a connection of at least one of the two electric machines EM1, EM2 by a spur gear train can also be provided.

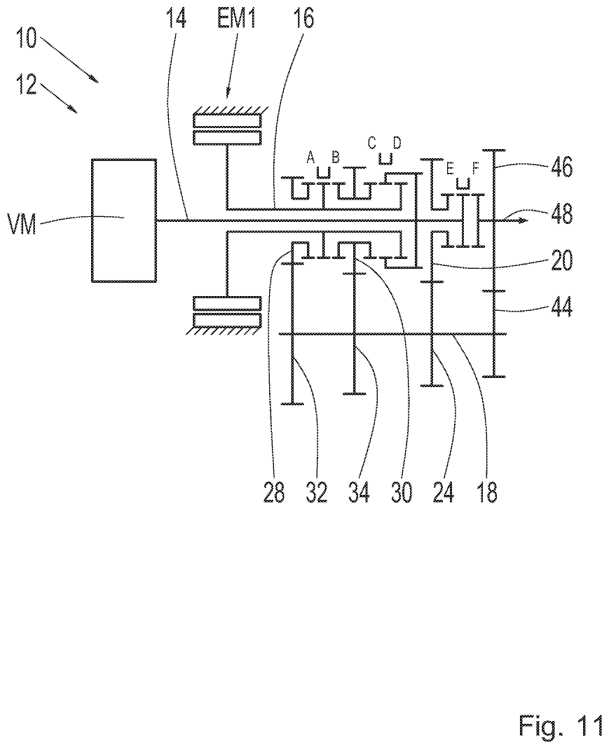

In FIG. 11, a tenth example variant of a hybrid transmission 10 according to the invention is shown in a drive train 12. In contrast to the hybrid transmission 10 shown in FIG. 1, a drive output is arranged coaxially to the transmission input shafts 14, 16. Here, the drive output is formed by a gearwheel pair, which is formed from a fixed gear 44 on the countershaft 18 and a fixed gear 46 on an output shaft 48. The output shaft 48 is arranged coaxially to the two transmission input shafts 14, 16. This arrangement makes it possible to establish a direct gear step, i.e., the direct connection of the first transmission input shaft 14 to the output shaft 48 by the shift element F. In this example, the fourth gear step is established as a direct gear. The electric prime mover EM1 is arranged coaxially to the transmission input shafts 14, 16 and is drivingly connected to the second transmission input shaft 16. The second transmission input shaft 16, for all intents and purposes, forms the rotor of the electric prime mover EM1. A pre-ratio (not represented) for the electric prime mover EM1, for example of a planetary design, could also be utilized. It is understood that shift elements can be arranged on the countershaft 18 in this example embodiment as well. It is also conceivable to arrange the shift element D at a transmission input, i.e., adjacent to the internal combustion engine VM. In addition, a second electric prime mover EM2 and/or a separating clutch K0 can be provided.

The invention was comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. The mere mention of a few measures in multiple various dependent claims is not to be understood to mean that a combination of these measures cannot also be advantageously utilized.

In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid transmission

12 drive train

14 first transmission input shaft

16 second transmission input shaft

18 countershaft

20 idler gear of the third spur gear stage

22 idler gear of the fourth spur gear stage

24 fixed gear of the third spur gear stage

26 fixed gear of the fourth spur gear stage

28 idler gear of the first spur gear stage

30 idler gear of the second spur gear stage

32 fixed gear of the first spur gear stage

34 fixed gear of the second spur gear stage

36 differential

38 gear shift matrix

40 further countershaft

42 fixed gear of the third and fourth spur gear stages

44 fixed gear

46 fixed gear

48 output shaft

VM internal combustion engine

EM1 first electric prime mover

EM2 second electric prime mover

i1 first spur gear stage

i2 second spur gear stage

i3 third spur gear stage

i4 fourth spur gear stage

iab output spur gear stage

iab2 further output spur gear stage

A shift element

B shift element

C shift element

D shift element

E shift element

F shift element

K0 separating clutch

1-12. (canceled)

13. A hybrid transmission (10) for a motor vehicle with an internal combustion engine (VM) and an electric prime mover (EM1), the hybrid transmission (10) comprising:
a first transmission input shaft (14) for a first sub-transmission;
a second transmission input shaft (16) for a second sub-transmission;
at least one countershaft (18);
a plurality of gear change devices (A-F) for engaging a plurality of gear steps (E1, E2, 1, 2, 3, 4); and
a plurality of idler gears (28, 30, 20, 22) and a plurality of fixed gears (32, 34, 24, 26) arranged in multiple gear set planes for forming the gear steps,
wherein a portion of the gear steps are engageable for the internal combustion engine (VM), and a portion of the gear steps are engageable for the electric prime mover (EM1), and
wherein at least one of the gear steps is engageable for both the internal combustion engine (VM) and the electric prime mover (EM1) regardless of the gear step engaged for the respective one of the internal combustion engine (VM) and the electric prime mover (EM1).

14. The hybrid transmission (10) of claim 13, wherein:
the plurality of gear steps is four gear steps;
the first and second gear steps (E1, E2) of the four gear steps are engageable for the electric prime mover (EM1);
the second gear step (E2, 2) is engageable for the internal combustion engine (VM) and for the electric prime mover (EM1);
the first, second, second, third, and fourth gear steps (1, 2, 3, 4) of the four gear steps are engageable for the internal combustion engine (VM) when the first gear step (E1) is engaged for the electric prime mover (EMI); and
the second, third, and fourth gear steps of the four gear steps (2, 3, 4) are engageable for the internal combustion engine (VM) when the second gear step (E2) is engaged for the electric prime mover (EMI).

15. The hybrid transmission (10) of claim 13, wherein:
the first transmission input shaft (14) and the second transmission input shaft (16) are arranged coaxially; and
one of the plurality of gear change devices (A-F), in one shift position, drivingly connects the first and second transmission input shafts (14, 16) to each other.

16. The hybrid transmission (10) of claim 13, wherein
the gear change devices (A-F) are double shift elements (AB, CD, EF), each of which is actuatable by a double-acting actuator; and
the two of the plurality of gear steps engageable for the electric prime mover (EM1) are engageable by one of the double shift elements (AB).

17. The hybrid transmission (10) of claim 13, wherein an idler gear (30) of the plurality of idler gears (28, 30, 20, 22) of the gear set that forms the second gear step (E2, 2) is arranged at a hollow shaft.

18. The hybrid transmission (10) of claim 13, wherein:
the electric prime mover (E1) is actuatable as an integrated starter generator for starting the internal combustion engine (VM); or
the electric prime mover (E1) is actuatable as a charging generator for charging an energy accumulator or for supplying a main power circuit; or
the electric prime mover (E1) is actuatable as both the integrated starter generator for starting the internal combustion engine (VM) and the charging generator for charging the energy accumulator or for supplying the main power circuit.

19. The hybrid transmission (10) of claim 13, wherein the internal combustion engine (VM) is directly operatively connected to the first transmission input shaft (14), and the electric prime mover (EM1) is actuatable as a starting component for starting the motor vehicle.

20. The hybrid transmission (10) of claim 13, wherein the second transmission input shaft (16) is a hollow shaft and at least partially encompasses the first transmission input shaft (14).

21. A drive train (12), comprising:
the internal combustion engine (VM) for providing input power;
the electric prime mover (EM1) for providing input power; and
the hybrid transmission (10) of claim 13.

22. The drive train of claim 21, wherein:
the electric prime mover (EM1) is at least partially actuatable as a supporting force during gear changes of the internal combustion engine (VM); or
the internal combustion engine is at least partially actuatable as a supporting force during gear changes of the electric prime mover; or
both the electric prime mover (EM1) is at least partially actuatable as the supporting force during gear changes of the internal combustion engine (VM) and the internal combustion engine is at least partially actuatable as the supporting force during gear changes of the electric prime mover.

23. The drive train (12) of claim 21, further comprising a second electric prime mover (EM2) connected in series with the internal combustion engine (VM) on the first transmission input shaft (14).

24. A motor vehicle, comprising:
an energy accumulator for storing energy for supplying electric prime movers and vehicle electronics;
a main power circuit for transmitting energy from the energy accumulator and/or from an electric prime mover operated as a charging generator; and
the drive train (12) of claim 21.
